(19) United States
(12) Patent Application Publication
(10) Pub. No.: US 2025/0138163 A1
(43) Pub. Date: May 1, 2025

(54) Strain Sensors for Microelectromechanical System (MEMS) Devices

(71) Applicant: Microvision, Inc., Redmond, WA (US)

(72) Inventors: Dirk Tenne, Bellevue, WA (US); Amin Abbasalipour, Kirkland, WA (US)

(73) Assignee: Microvision, Inc., Redmond, WA (US)

(21) Appl. No.: 18/494,136

(22) Filed: Oct. 25, 2023

(51) Int. Cl. G01S 7/481; G01L 1/18

(52) U.S. Cl. CPC G01S 7/4817; G01L 1/18; G01S 7/4814

(57) ABSTRACT

The embodiments described herein include strain sensors with piezoresistive elements that are formed proximate opposite surfaces of the substrate. Specifically, the strain sensors include piezoresistive elements in a Wheatstone bridge where two piezoresistive elements are disposed proximate one surface, while the other two piezoresistive elements are disposed proximate the opposite surface. This can provide increased sensitivity to certain types of motion (e.g., torsional motion) and/or reduced sensitivity to other types of motion (e.g., lateral motions).

### FIELD

The present disclosure generally relates to sensors, and more particularly relates to strain sensors used in microelectromechanical system (MEMS) based devices.

### BACKGROUND

Microelectromechanical system (MEMS) devices are used in a wide variety of applications. For example, MEMS devices are used in scanning laser devices that are themselves implemented for a wide variety of applications, including object detection and image projection. For example, light detection and ranging (LiDAR) systems have been developed for object detection and ranging. In some applications LiDAR systems have been implemented to 3D maps of surfaces, where the 3D maps describe the variations in depth over the surface. Such object detection and depth mapping have been used in a variety of applications, including navigation and control. For example, such LiDAR devices are being used in the navigation and control of autonomous vehicles, including autonomous devices used for transportation and manufacturing.

In scanning laser devices, laser light is reflected off one or more scanners to generate a scanning pattern. Such scanning laser devices commonly require precise control of the scanner and utilize MEMS devices to provide such precise control. To further facilitate such precise control MEMS devices may include one or more sensors used for position sensing (including motion sensing) during operation of device. Unfortunately, such sensors may be sensitive to other modes of motion in the scanner and this can limit the accuracy of the sensor in providing the desired position and/or motion sensing, for example, a sensor implemented to sense torsion in the scanner may also be sensitive to lateral movements in the scanner, and this sensitivity to lateral movement can limit the sensitivity and/or accuracy of the desired torsional sensing.

Thus, there remains a continuing need for sensors that can provide high sensitivity to certain types of motion while limiting unwanted sensitivity to other types of motion.

### BRIEF DESCRIPTION OF THE DRAWINGS

FIG. 1 shows a schematic diagram of a scanner including a strain sensor in accordance with various embodiments;

FIG. 2A shows a circuit diagram of strain sensor in accordance with various embodiments;

FIGS. 2B and 2C show schematic diagrams of a strain sensor in accordance with various embodiments;

FIG. 3A shows top and cross-sectional views of a piezoresistive element in accordance with various embodiments;

FIG. 3B shows a perspective view of an exemplary strain sensor in accordance with various embodiments;

FIG. 3C shows a perspective view scanner including a strain sensor in accordance with various embodiments;

FIG. 4 shows a schematic diagram of a scanning laser device in accordance with various embodiments of the present invention;

FIG. 5 shows a schematic diagram of a scanning light detection and ranging (LiDAR) system in accordance with various embodiments of the present invention;

FIGS. 6A and 6B show side and top views of a scanning laser device in accordance with various embodiments;

FIGS. 7A and 7B show a side view and a top view of a transmit module in accordance with various embodiments;

FIGS. 8A and 8B show a side view and a top view of a receive module in accordance with various embodiments; and

FIG. 9 shows a perspective view of an integrated photonics module in accordance with various embodiments of the present invention.

### DESCRIPTION OF EMBODIMENTS

The embodiments described herein include sensors that can be used in a variety of implementations and applications. As will be described in greater detail below, these sensors can have increased sensitivity to certain types of motion (e.g., torsional motion) and/or reduced sensitivity to other types of motion (e.g., lateral motions).

In one embodiment, a strain sensor is implemented to include four piezoresistive elements electrically coupled together in a Wheatstone bridge circuit that is configured to respond to strain in a substrate. And in accordance with the embodiments described herein, the piezoresistive elements are formed proximate opposite surfaces of the substrate. Specifically, two of the piezoresistive elements in the Wheatstone bridge are disposed proximate one surface, while the other two piezoresistive elements are disposed proximate the opposite surface. As will be described in greater detail below, disposing the piezoresistive elements proximate opposite surfaces can provide a strain sensor that has increased sensitivity to certain types of motion (e.g., torsional motion) and/or has reduced sensitivity to other types of motion (e.g., lateral motions) that results in improved sensor accuracy.

These embodiments provide strain sensors that can be implemented in a variety of devices and for a variety of applications. For example, these embodiments can be implemented in scanning laser devices, including scanning laser devices that use microelectromechanical system (MEMS) scanners as part of a light detection and ranging (LiDAR) system. The embodiments described herein can further provide strain sensors that can be implemented in other scanner devices and other MEMS devices.

In one specific embodiment the strain sensor is implemented on a scanner, where the scanner includes a scan plate, a first flexure, and a scanner frame formed from semiconductor substrate (e.g., a MEMS substrate). In this embodiment the strain sensor is disposed in the semiconductor substrate and configured to sense strain in the semiconductor substrate. For example, the strain sensor can be configured to respond to changes in strain and provide a signal indicative of these changes, and such a signal can be used to determine the position of the scan plate. Specifically, the strain sensor can be implemented with two of the piezoresistive elements in the Wheatstone bridge disposed proximate one surface of the semiconductor substrate, while the other two piezoresistive elements are disposed proximate the opposite surface. By disposing the piezoresistive elements in the strain sensor proximate opposite surfaces of the substrate increased sensitivity to certain types of motion (e.g., torsional motion) and/or reduced sensitivity to other types of motion (e.g., lateral motions) can be provided. Such a sensor can provide improved sensor sensitivity in a variety of implementations and applications.

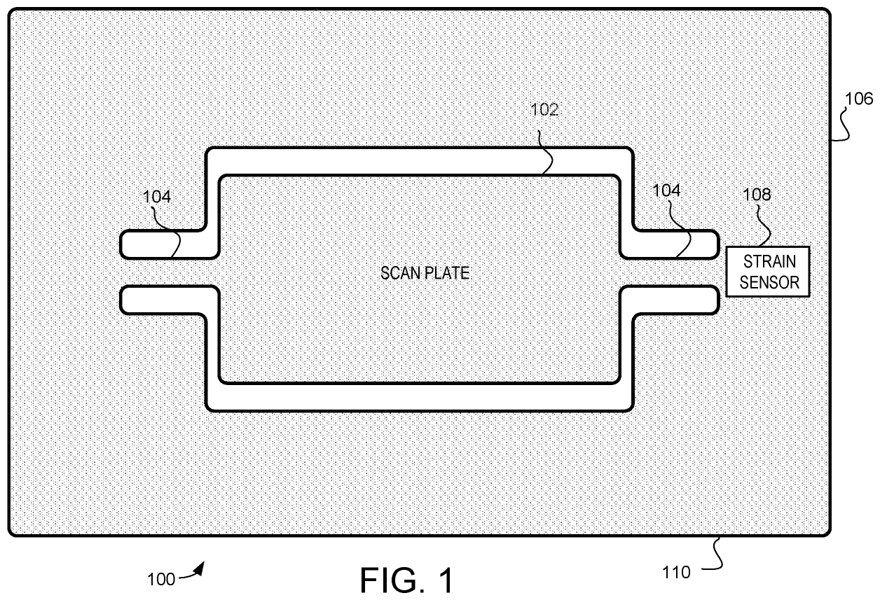

Turning now to FIG. 1, an exemplary scanner 100 is illustrated schematically. The scanner 100 includes a scan plate 102, at least one flexure structure 104, a scanner frame 106, and a strain sensor 108. In a typical embodiment, the scan plate 102, flexure structures 104 and scanner frame 106 are all formed from a microelectromechanical (MEMS) semiconductor substrate 110. In this illustrated the scanner frame 106 is a unitary structure that completely surrounds the scan plate 102 and the flexure structures 104. However, in other embodiments the scanner frame 106 only partially surrounds the scan plate 102 and/or flexure structures 104. Furthermore, in other embodiments the scanner frame 106 includes multiple components (e.g., multiple separate MEMS substrates or other structures).

During operation, the flexure structures 104 facilitate motion of the scan plate 102 relative to the scanner frame 106. In one embodiment, these flexure structures 104 comprise torsion arms that facilitate angular movement of the scan plate 102 about a rotation axis by twisting when an external electromotive force is applied. In these embodiments the strain sensor 108 can be implemented as or considered to be a torsion sensor that is used to measure principal strains as a result of a torsional stress state and outputs an electrical potential proportional to the angular movement/displacement of scan plate 102 relative to the scanner frame 106. In other embodiments, these flexure structures 104 comprise bending arms or bending beams that facilitate angular movement of the scan plate 102 by bending. It should be noted that while FIG. 1 illustrates two flexure structures 104, in other embodiments more or less flexure structures 104 may be used. For example, a single flexure structure 104 may be implemented as a cantilevered torsion arm to facilitate angular movement of the scan plate 102.

In general, the strain sensor 108 is configured to respond to strain in the substrate 110 and can be used to determine the relative motion of the scan plate 102 and/or flexure structures 104. In one embodiment, a strain sensor 108 is implemented to include four piezoresistive elements electrically coupled together in a Wheatstone bridge circuit that is configured to respond to strain in a substrate 110. And in accordance with the embodiments described herein, the piezoresistive elements are formed proximate opposite surfaces of the substrate 110. Specifically, two of the piezoresistive elements in the Wheatstone bridge are disposed proximate one surface of the substrate 110, while the other two piezoresistive elements are disposed proximate the opposite surface of the substrate 110.

In general, disposing the piezoresistive elements proximate opposite surfaces of the substrate 110 can provide a strain sensor 108 with increased sensitivity to certain types of motion (e.g., torsional motion) and/or has reduced sensitivity to other types of motion (e.g., lateral motions). As will be discussed in greater detail below, strain sensor 108 can provide an increase in the relative signal activity due to torsional strains and thus can provide improved sensitivity to torsional motion and the resulting angular movement or angular displacement of the scan plate 102. Furthermore, in some embodiments the strain sensor 108 effectively provides a “filtered” signal with improved signal-to-noise ratio. Specifically, in these embodiments the effects of strains caused by lateral motions are at least partially cancelled by the strain sensor 108, resulting in less signal activity due to these lateral motions.

This partial cancellation of signal activity due to lateral motions can improve the signal-to-noise ratio and provide a signal with reduced harmonic distortions. Specifically, lateral motions of the scan plate 102 can generate higher mode signals with higher frequencies than the signals caused by torsional motion. When amplified, these high frequency signals can cause harmonic distortions. While these harmonic distortions can be filtered in some applications, this would require additional computing power and can cause an undesired increase in signal latency. By partially or completely canceling the signals due to lateral motions these harmonic distortions are reduced without requiring the computing power for filtering and the resulting signal latency. Thus, the strain sensor 108 can reduce the effects of lateral motions and reduce the need for additional signal filtering or other post processing.

In one embodiment the scan plate 102, the flexure structure(s) 104, and scanner frame 106 are formed from a MEMS semiconductor substrate 110, where the MEMS semiconductor substrate has a first surface and a second surface opposite the first surface. In this embodiment the strain sensor 108 is disposed on the MEMS semiconductor substrate 110 and includes a first, a second, a third and a fourth piezoresistive elements electrically coupled together to form a Wheatstone bridge circuit, where the first and the second piezoresistive elements are disposed proximate the first surface of the MEMS semiconductor substrate 110, and where the third and fourth piezoresistive elements are disposed proximate the second surface of the MEMS semiconductor substrate 110.

In such an embodiment the Wheatstone bridge circuit also includes a first sensing node between the first and the second piezoresistive elements and includes a second sensing node between the third and fourth piezoresistive elements. So configured, the Wheatstone bridge circuit provides a signal indicative of the strain in the MEMS semiconductor substrate 110. In some embodiments this signal can also provide a signal indicative of angular movement (e.g., angular displacement or rotation) of the scan plate 102 about rotation axis at the first sensing node and second sensing node.

It should be noted that while FIG. 1 illustrates the strain sensor 108 on the scanner frame 106 portion of the substrate 110, that other configurations are possible. For example, one or more components of the stain sensor 108 may be formed on different components (e.g., the scan plate 102, the flexure structures 104, the scanner frame 106). For example, in some embodiments one or more of the first, second, third and fourth piezoresistive elements may be formed on a flexure structure 104 and/or the scan plate 102.

In one embodiment the first piezoresistive element has a first current axis, the second piezoresistive element has a second current axis, the third piezoresistive element has a third current axis, and the fourth piezoresistive element has a fourth current axis. In such an embodiment the first piezoresistive element and the third piezoresistive element may be disposed such that the first current axis is parallel to the third current axis in the MEMS semiconductor substrate 110, and the second piezoresistive element and the fourth piezoresistive element may be disposed such that the second current axis is parallel to the fourth current axis in the MEMS semiconductor substrate 110.

In such embodiments the first piezoresistive element and the second piezoresistive element may be disposed such that the first current axis is perpendicular to the second current axis in the MEMS semiconductor substrate 110 and the third piezoresistive element and the fourth piezoresistive element are disposed such that third current axis is perpendicular to the fourth current axis in the MEMS semiconductor substrate 110.

In such an embodiment the first flexure structure can provide for angular movement of the scan plate 102 about a rotation axis, and wherein the first piezoresistive element and the second piezoresistive element can be disposed on substantially opposing sides of the rotation axis and wherein the third piezoresistive element and the fourth piezoresistive element can be disposed on substantially a same side of the rotation axis.

In such an embodiment the flexure structure(s) 104 may provides for angular movement of the scan plate about a rotation axis, and the first piezoresistive element and the second piezoresistive element may be disposed such that the first current axis and the second current axis intersect at the rotation axis and wherein the third piezoresistive element and the fourth piezoresistive element may be disposed such that third current axis and the fourth current axis intersect at a point offset from the rotation axis.

In such an embodiment the first piezoresistive element and the third piezoresistive element may be disposed such that the first current axis is coplaner with the third current axis in the MEMS semiconductor substrate 110.

In such an embodiment the flexure structure(s) 104 may provide angular movement of the scan plate 102 about a rotation axis and where the first surface and the second surface are on substantially opposing sides of the rotation axis, and wherein the first and the second piezoresistive elements are disposed a first distance from the rotation axis, and wherein the third and fourth piezoresistive elements are disposed a second distance from the first axis, and wherein the first distance and the second distance are substantially equal.

In one embodiment the scan plate 102, flexure structures 104 and scanner frame 106 are all formed together from a unitary MEMS semiconductor substrate. In such a process a wafer of semiconductor material is provided and the scan plate 102, flexure structures 104 and scanner frame 106 are all formed from the wafer. In such a process the scan plate 102, flexure structures 104 and scanner frame 106 are all formed together from the semiconductor wafer using any suitable MEMS fabrication technique, including any photolithography and micromachining techniques. As one example, in a typical embodiment, the scan plate 102, flexure structures 104, scanner frame 106 and strain sensor 108 would be photolithographically formed using a wafer of single-crystal silicon. However, use of polycrystalline silicon or combination of single and polycrystalline silicon can also be used to achieve the desired structures. In yet other embodiments, other materials such as gallium arsenide (GaAs) or silicon carbide (SiC) can be used.

In such techniques, the scan plate 102, flexure structures 104, scanner frame 106 and strain sensor 108 for multiple scanners 100 can be patterned from a single wafer using a variety of photolithographic techniques, and then the individual scanners separated and removed. For example, the scan plate 102, flexure structures 104 and scanner frame 106 for multiple scanners 100 can be at least partially defined from the semiconductor substrate using etching. In such an embodiment this etching can be used to improve the performance of the scanner 100. For example, in some embodiments the scanner frame 106 includes one or more outer perimeter edges that are that are at least partially defined using etching. Defining at least a portion of these outer perimeter edges using etching can provide edges that are smoother than those defined using other techniques such as laser cutting or saw dicing. This increased smoothness in these outer perimeter edges can improve the ability of the scanner frame 106 to handle stress at those edges, and thus can improve the reliability of the scanner 100. In one embodiment these edges are defined by etching slots to define these outer perimeter edges.

In these embodiments the first surface and the second surface can correspond to the die surfaces or wafer surfaces, i.e., those surfaces created by the slicing and/or processing of bulk semiconductor to form a wafer substrate. In such an embodiment the various circuit elements (piezoresistive elements, conductors, etc.) are formed proximate a first wafer slice surface and a second wafer slice surface.

Specifically, various semiconductor fabrication techniques and other processes may be used to form other elements on scanner 100, including sensors (e.g., strain sensor 110), actuators (e.g., piezoelectric actuators) and various conductive elements. For example, these techniques can include the doping, deposition and patterning of metallization to form channels, conductive traces, contacts and other such elements that comprise the strain sensor 108. Stated another way, four piezoresistive elements configured as Wheatstone bridge circuit and the associated conductive elements between those elements can be formed on the substrate 110 with any suitable combination of doping, deposition and patterning or any other techniques.

The scan plate 102 provides the scanning surface used to reflect laser light during operation. As such, the scanning surface of the scan plate 102 can be formed to include a variety of specialized shapes, structures and/or coatings. For example, in some embodiments additional reflective or diffractive coatings can be applied to the surface of the scan plate.

For example, optical coatings can be applied to the scanning surface improve the reflectively of the surface at the wavelengths of interest, including infrared and visual color wavelengths. As another specific example, the scanning surface of the scan plate 102 can be formed with additional processing to improve or alter the axis of the planarity of the scanning surface. As another specific example, the scanning surface of the scan plate 102 can be formed with non-planar optical surface.

In other embodiments a separate mirror or other structure can formed and coupled to the scan plate 102 to provide the scanning surface. In such cases the separate mirror can include structures and/or materials that would be difficult to form with or otherwise incompatible with MEMS fabrication techniques.

As was mentioned above, the scanner 100 can be implemented in scanning laser devices, including scanning laser projectors and laser depth scanners. In such an embodiment, the scanning laser device can be implemented with a drive circuit configured to provide drive signals to one or more actuators, where the actuators generate motion in the scan plate 102 in response to the drive signals. In all cases, the resulting motion of the scan plate 102 reflects laser light into a pattern of scan lines, and thus can facilitate scanning, projection, or any other suitable laser scanning function.

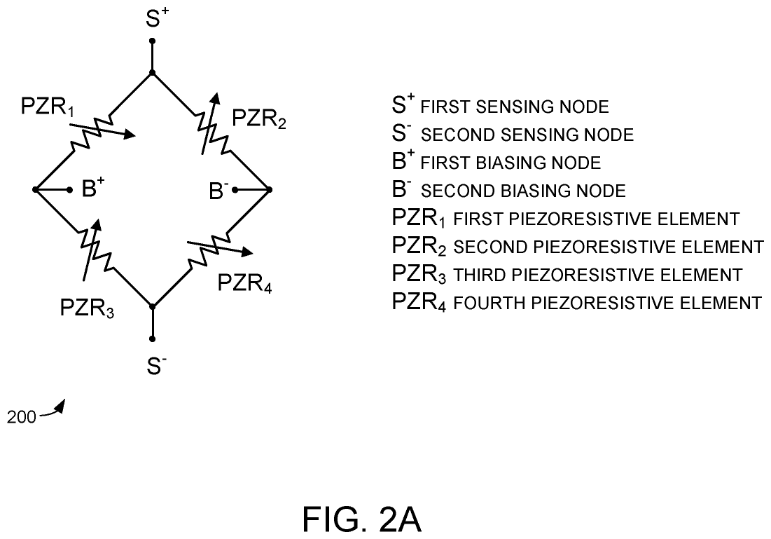

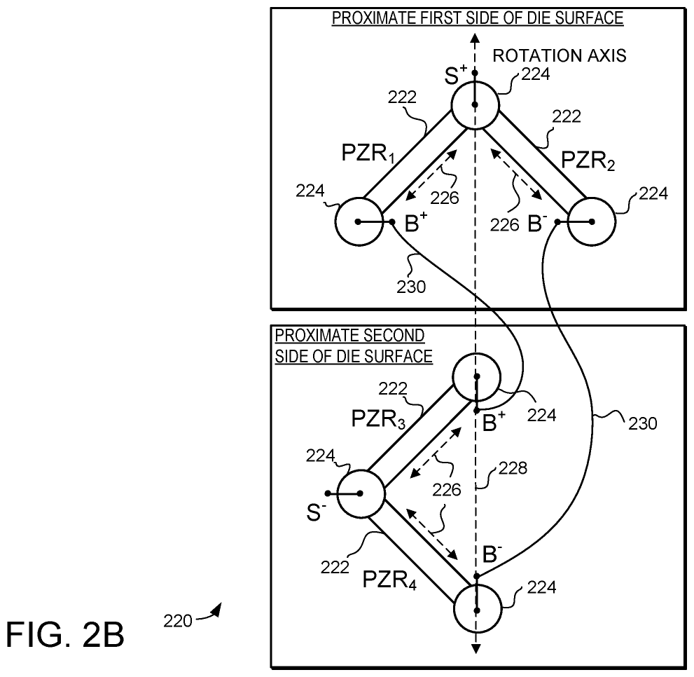

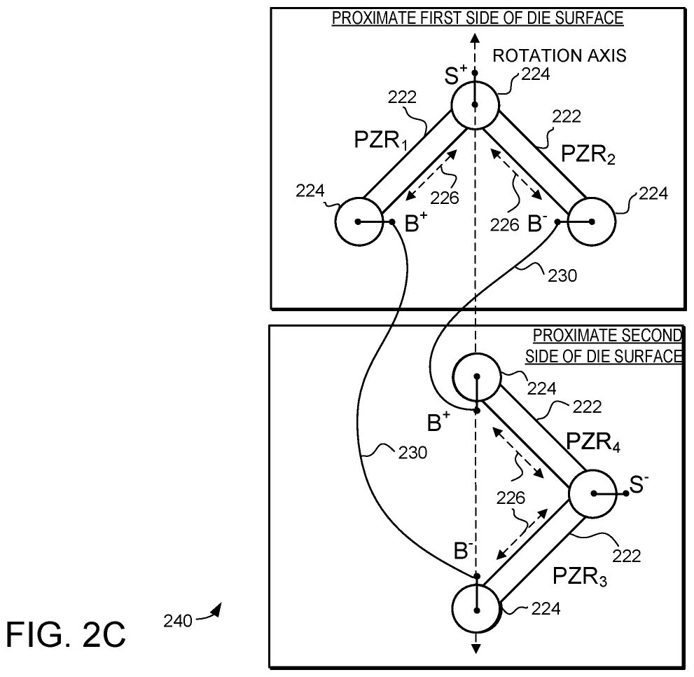

Turning now to FIG. 2A, a circuit diagram illustrates an exemplary strain sensor 200. The strain sensor 200 is an example of one type of strain sensor that can implemented on a scanner in accordance with the embodiments described herein. The strain sensor 200 includes four piezoresistive elements (labeled PZR₁, PZR₂, PZR₃, and PZR₄) that are electrically coupled together to form a Wheatstone bridge circuit. The strain sensor 200 includes two sensing nodes S⁺ and S⁻ and two biasing nodes B⁺ and B⁻.

When suitably implemented an appropriate bias signal is applied to the biasing nodes B⁺ and B⁻ during operation of the strain sensor 200, and the strain sensor 200 circuit generates a sensing signal at sensing nodes S⁺ and S⁻. In the unconstrained state, e.g., no rotation or angular displacement of the scan plate, the bridge is balanced and the sensing signal diminishes. In general, the sensing signal at sensing nodes S⁺ and S⁻ is indicative of resistance changes in the piezoresistive elements caused by strain in the associated substrate. And in some embodiments this sensing signal at sensing nodes S⁺ and S⁻ can be used to provide an indication about a rotation axis (e.g., angular movement of the scan plate 102 about a rotation axis and relative to the scanner frame 106).

To facilitate this each of the four piezoresistive elements (PZR₁, PZR₂, PZR₃, and PZR₄) in the strain sensor 200 is implemented to have an electrical impedance that changes in response to strain caused by the application of a mechanical stress. Depending on the type of applied mechanical stresses the piezoresistive elements may independently increase or decrease in electrical impedance.

In a typical implementation the four piezoresistive elements (PZR₁, PZR₂, PZR₃, and PZR₄) are configured to have substantially equal impedance when no strain is present. The application of stress on the substrate causes strain that increases or decreases the impedance of one or more of the piezoresistive elements. This change in impedance is dependent upon a coefficient of resistivity dependence for the piezoresistive element and the magnitude and direction of strain in substrate relative to the piezoresistive element. The change in strain changes the impedance of one or more of the piezoresistive elements, and this creates an unbalanced bridge causing a signal at signal at sensing nodes S⁺ and S⁻. Thus, the sensing signal is indicative of strain in the associated substrate.

Such piezoresistive elements can be fabricated using a wide variety of materials. For example, the piezoresistive elements can be formed from diffused channels and/or wells within an appropriate semiconductor substrate. As specific examples, p− or n− channels in a n− or p− substrate can be used to form diffused impedances that will exhibit a change in impedance in response to mechanical strain on the substrate. In one specific embodiment, each piezoresistive element will have a base impedance under no strain conditions and will exhibit an increase in impedance as strain increases. Notably, the amount of impedance change is dependent upon the direction of the strain applied relative to the piezoresistive element. Accordingly, the four piezoresistive elements (PZR₁, PZR₂, PZR₃, and PZR₄) are preferably implemented with some piezoresistive elements having different alignment axes relative to each other and relative to any rotation axis. Details of such arrangements will be discussed in greater detail below.

In accordance with the embodiments described herein, the first piezoresistive element PZR₁ and the second piezoresistive element PZR₂ are disposed proximate a first surface of the MEMS semiconductor substrate, while the third piezoresistive element PZR₃ and the fourth piezoresistive element PZR₄ are disposed proximate the second surface of the MEMS semiconductor substrate, where the second surface is opposite the first surface.

Next, it should be noted that while the circuit diagram of FIG. 2A illustrates the four piezoresistive elements (PZR₁, PZR₂, PZR₃, and PZR₄) in a physical “diamond configuration” that is merely illustrative of circuit topology. As will described in greater detail below in some embodiments various piezoresistive element in the strain sensor 200 may be physically “rotated” and/or “shifted” relative to such a diamond configuration.

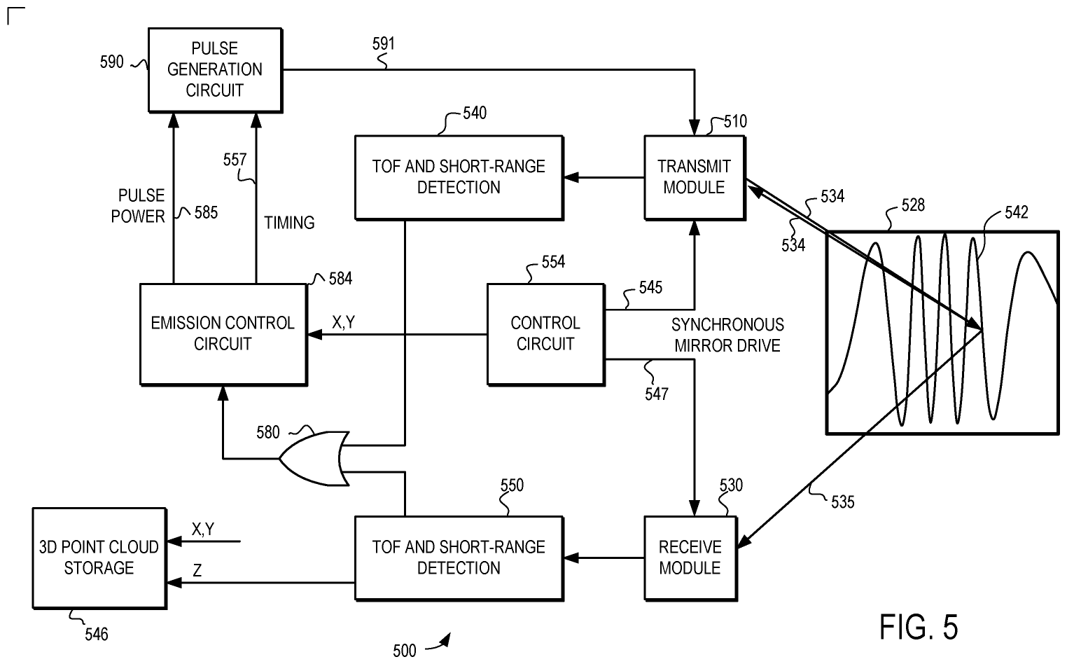

Turning now to FIG. 2B, a schematic diagram illustrates an exemplary strain sensor 220. The strain sensor 220 is an example of one type of strain sensor that can be implemented on a scanner in accordance with the embodiments described herein. As with the strain sensor 200 in FIG. 5A, the strain sensor 220 includes four piezoresistive elements (labeled PZR₁, PZR₂, PZR₃, and PZR₄) that are electrically coupled together to form a Wheatstone bridge circuit. The strain sensor 220 again includes two sensing nodes S⁺ and S⁻ and two biasing nodes B⁺ and B⁻. Each piezoresistive element includes a piezoresistive body 222 between to contact structures 224. As will be described in greater detail below these piezoresistive bodies 222 comprise appropriately doped channels and/or wells in substrate, and the contact structures 224 can comprise wells and/or other conductive structures. Finally, each piezoresistive element has a current axis 226 (denoted by dashed arrows) that is parallel to a direction of net current flow in the piezoresistive element during operation of the strain sensor 220. In typical piezoresistive elements the current axis 226 is related to the primary sensing direction, i.e., the direction of strain that predominately changes the resistivity of the element. For example, the primary sensing direction of each piezoresistive element may be perpendicular to its current axis 226. Of course, other configurations are possible in other types of piezoresistive elements.

Also illustrated in FIG. 2B is a rotation axis 228. As described above, this rotation axis 228 can represent the axis of rotation of scan plate (e.g., scan plate 102 of FIG. 1) provided by one or more flexure structures (e.g., flexure structures 104 of FIG. 1) relative to a scanner frame (e.g., scanner frame 106 of FIG. 1).

Also illustrated in FIG. 2B are conductive elements 230. These conductive elements 230 each provide an electrical coupling between a piezoresistive element proximate the first surface and another piezoresistive element proximate the second surface. Specifically, in this illustrated example one conductive element 230 provides an electrical connection between contact structures 224 for PZR₁ and PZR₃ at the biasing node B⁺ and another conductive element 230 provides an electrical connection between contact structures 224 for PZR₂ and PZR₄ at biasing node B⁻. As will be described in greater detail below, these conductive elements between piezoresistive elements that are proximate different surfaces can be implemented with a variety of different structures and elements. For example, a combination of vertical interconnects, conductive traces, bonding wires, pads and/or other conductive elements may be used to provide such conductive elements 230.

In the strain sensor 220 illustrated in FIG. 2B, the first piezoresistive element PZR₁ and the second piezoresistive element PZR₂ are disposed proximate a first surface of the MEMS semiconductor substrate, while the third piezoresistive element PZR₃ and the fourth piezoresistive element PZR₄ are disposed proximate the second surface of the MEMS semiconductor substrate, where the second surface is opposite the first surface. Furthermore, in this example the third piezoresistive element PZR₃ and the fourth piezoresistive element PZR₄ are rotated and shifted relative to a standard diamond configuration.

Notably, in this illustrated embodiment the first piezoresistive element PZR₁ and the second piezoresistive element PZR₂ are disposed such that the current axis 226 of PZR₁ is perpendicular to the current axis 226 of PZR₂. Likewise, the third piezoresistive element PZR₃ and the fourth piezoresistive element PZR₄ are disposed such that current axis 226 of PZR₃ is perpendicular to the current axis 226 of PZR₄. Furthermore, the first piezoresistive element PZR₁ and the second piezoresistive element PZR₂ are disposed such that the current axis 226 of PZR₁ and the current axis 226 of PZR₂ intersect at the rotation axis 228, while the third piezoresistive element PZR₃ and the fourth piezoresistive element PZR₄ are disposed such that the current axis 226 of PZR₃ and the current axis of PZR₄ intersect 226 at a point offset from the rotation axis 228.

Also, in this illustrated example the first piezoresistive element PZR₁ and the second piezoresistive element PZR₂ are disposed on substantially opposing sides of the rotation axis 228, while the third piezoresistive element PZR₃ and the fourth piezoresistive element PZR₄ are disposed on substantially a same side of the rotation axis 228.

Turning now to FIG. 2C, a schematic diagram illustrates an exemplary strain sensor 240. The strain sensor 240 is an example of one type of strain sensor that can implemented on a scanner in accordance with the embodiments described herein. As with the strain sensor 200 in FIG. 2A, the strain sensor 240 includes four piezoresistive elements (labeled PZR₁, PZR₂, PZR₃, and PZR₄) that are electrically coupled together to form a Wheatstone bridge circuit. The strain sensor 240 again includes two sensing nodes S⁺ and S⁻ and two biasing nodes B⁺ and B⁻. Each piezoresistive element includes a piezoresistive body 222 between to contact structures 224. Each piezoresistive element has a current axis 226 (denoted by dashed arrows) that is parallel to a direction of net current flow in the piezoresistive element during operation of the strain sensor 240. Again, in this example, the current axis 226 of each piezoresistive element also corresponds to its primary sensing direction, i.e., the direction of strain that predominately changes the resistivity of the element. Also illustrated in FIG. 2C is a rotation axis 228 and conductive elements 230. Again, in this example one conductive element 230 provides an electrical connection between contact structures 224 for PZR₁ and PZR₃ at the biasing node B⁺ and another conductive element 230 provides an electrical connection between contact structures 224 for PZR₂ and PZR₄ at biasing node B⁻.

Again, in the strain sensor 240 illustrated in FIG. 2C, the first piezoresistive element PZR₁ and the second piezoresistive element PZR₂ are disposed proximate a first surface of the MEMS semiconductor substrate, while the third piezoresistive element PZR₃ and the fourth piezoresistive element PZR₄ are disposed proximate the second surface of the MEMS semiconductor substrate, where the second surface is opposite the first surface. Furthermore, in this example the third piezoresistive element PZR₃ and the fourth piezoresistive element PZR₄ are rotated and shifted relative to a standard diamond configuration.

Notably, in this illustrated embodiment the first piezoresistive element PZR₁ and the second piezoresistive element PZR₂ are disposed such that the current axis 226 of PZR₁ is perpendicular to the current axis 226 of PZR₂. Likewise, the third piezoresistive element PZR₃ and the fourth piezoresistive element PZR₄ are disposed such that current axis 226 of PZR₃ is perpendicular to the current axis 226 of PZR₄. Furthermore, the first piezoresistive element PZR₁ and the second piezoresistive element PZR₂ are disposed such that the current axis 226 of PZR₁ and the current axis 226 of PZR₂ intersect at the rotation axis 228, while the third piezoresistive element PZR₃ and the fourth piezoresistive element PZR₄ are disposed such that the current axis 226 of PZR₃ and the current axis of PZR₄ intersect 226 at a point offset from the rotation axis 228.

Also, in this illustrated example the first piezoresistive element PZR₁ and the second piezoresistive element PZR₂ are disposed on substantially opposing sides of the rotation axis 228, while the third piezoresistive element PZR₃ and the fourth piezoresistive element PZR₄ are disposed on substantially a same side of the rotation axis 228.

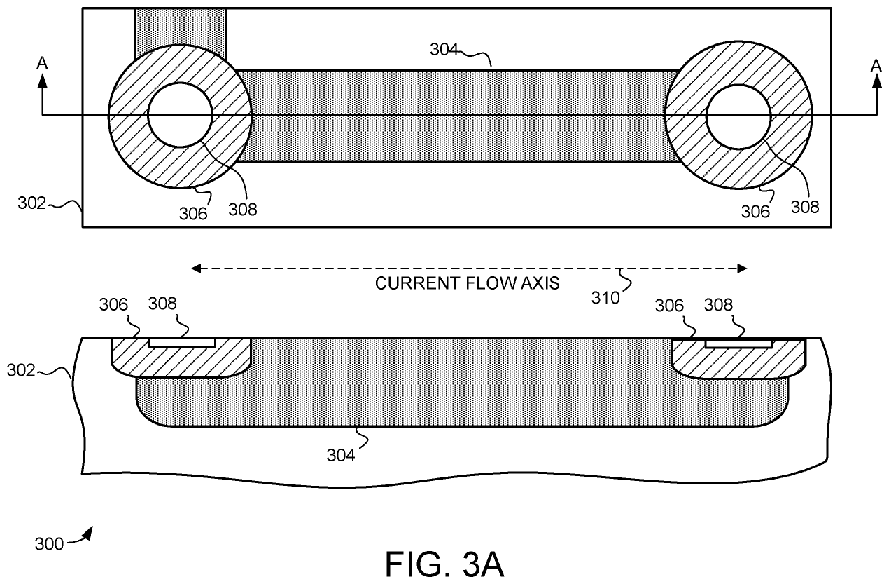

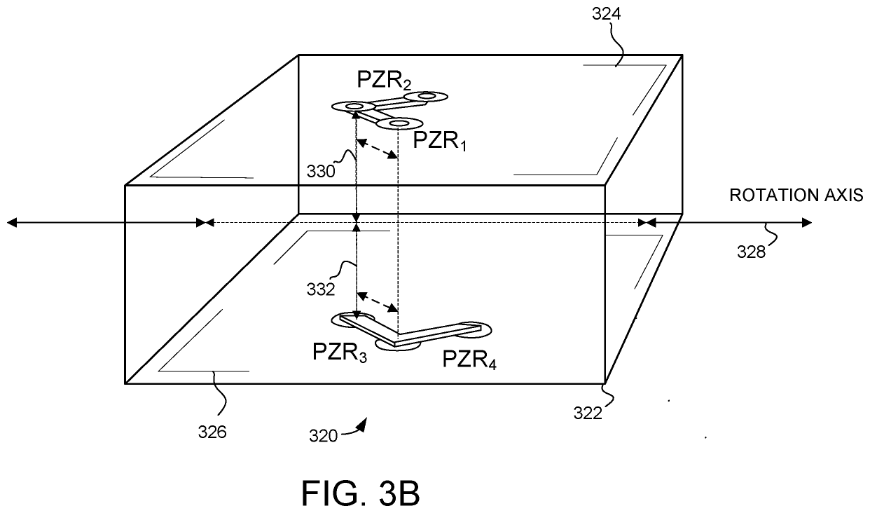

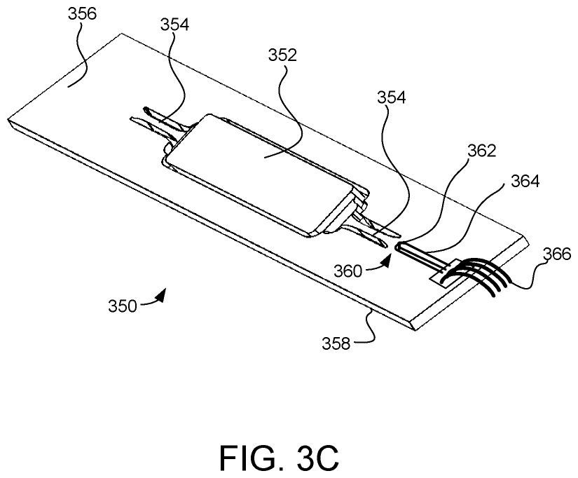

Turning now to FIG. 3A, a top view and cross-sectional side view taken along line A-A of a piezoresistive element 300 is illustrated. In this example, the piezoresistive element 300 is formed in a semiconductor substrate 302, and includes a doped channel 304, doped wells 306, and ohmic contacts 308. In general, the doped channel 304 can comprise any appropriately p− or n− doped channel formed to exhibit a change in impedance in response to mechanical strain on the substrate 302. The doped wells 306 can comprises any appropriately doped region configured to facilitate connection to the ohmic contacts 308 and can also prevent the unwanted formation of the P-N junction with the substrate 302. The ohmic contacts 308 provided electrical connection to the piezoresistive element 300. As one specific example, the doped channel 304 can comprise an appropriately n− doped channel, the doped wells 306 can comprise appropriately doped n⁺ doped wells, while the substrate 302 comprises a p− MEMS semiconductor substrate.

Notably, the piezoresistive element 300 has a current axis 310 (denoted by dashed arrows) that is parallel to a direction of net current flow in the piezoresistive element 300 during operation. In this implementation the current axis 310 is perpendicular to its primary sensing direction, i.e., the direction of strain that predominately changes the resistivity of the piezoresistive element 300. Stated another way, the piezoresistive element 300 will exhibit a relatively strong change in impedance in response to mechanical strain on the substrate 302 in the direction perpendicular to the current flow axis 310.

It should be noted that piezoresistive element 300 is just one example of the type of piezoresistive element that can be implemented in the various embodiments described herein.

Turning now to FIG. 3B, a perspective diagram illustrates an exemplary strain sensor 320. The strain sensor 320 is an example of one type of strain sensor that can be implemented on a scanner in accordance with the embodiments described herein. As with the strain sensor 200 in FIG. 2B, the strain sensor 320 includes four piezoresistive elements (labeled PZR₁, PZR₂, PZR₃, and PZR₄) that are electrically coupled together to form a Wheatstone bridge circuit in a semiconductor substrate 322. Not shown in FIG. 3B are the conductive elements providing electrical connection to the two sensing nodes S⁺ and S⁻ and two biasing nodes B⁺ and B⁻.

Also illustrated in FIG. 3B is a rotation axis 328. As described above, this rotation axis 328 can represent the axis of rotation or angular movement of scan plate (e.g., scan plate 102 of FIG. 1) provided by one or more flexure structures (e.g., flexure structures 104 of FIG. 1) relative to a scanner frame (e.g., scanner frame 106 of FIG. 1), all of which can be formed from the semiconductor substrate 322.

Not shown in FIG. 3B are the various conductive elements that provide an electrical coupling between a piezoresistive element proximate the first surface and another piezoresistive element proximate the second surface. Specifically, not shown are the conductive elements that provide an electrical connection between PZR₁ and PZR₃ at the biasing node B⁺. Also not shown is the conductive element that provides an electrical connection between PZR₂ and PZR₄ at biasing node B⁻. Again, such conductive elements can comprise any combination of vertical interconnects, conductive traces, bonding wires, pads and/or other conductive elements may be used to provide such connections.

In the strain sensor 320 illustrated in FIG. 3B, the first piezoresistive element PZR₁ and the second piezoresistive element PZR₂ are disposed proximate a first surface 324 of the semiconductor substrate 322, while the third piezoresistive element PZR₃ and the fourth piezoresistive element PZR₄ are disposed proximate the second surface 326 of the semiconductor substrate 322, where the second surface 326 is opposite the first surface 324. Furthermore, in this example the third piezoresistive element PZR₃ and the fourth piezoresistive element PZR₄ are rotated and shifted relative to a standard diamond configuration. Thus, the strain sensor 320 is similar to the strain sensor 220 illustrated in FIG. 2B.

In this illustrated embodiment the first piezoresistive element PZR₁ and third piezoresistive element PZR₃ are disposed on like positions relative to the rotation axis 328. More specifically, in this illustrated embodiment the first piezoresistive element PZR₁ and the third piezoresistive element PZR₃ are disposed such that the current axis of PZR₁ is coplanar to the current axis of PZR₃. This specific coplanar arrangement is illustrated by the dashed lines between PZR₁ and PZR₃. Such a coplanar configuration of piezoresistive elements proximate opposite surfaces results in PZR₁ and PZR₃ exhibiting impedance changes that are similar or the same in magnitude but opposite in direction when the substrate 322 is under torsional strain. This leads to an increase in signal and the sensing nodes, and such a coplanar configuration can thus increase the sensitivity of the strain sensor 320 to torsional strain. Furthermore, such a coplanar configuration proximate opposite surfaces results in PZR₁ and PZR₃ exhibiting impedance changes that are similar or the same in magnitude and in the same direction when the substrate 322 is under lateral strain. This leads to signal cancelation at the sensing nodes, and thus a coplanar configuration can decrease the sensitivity of the strain sensor 320 laterally induced strains. Taken together, this can improve ability to detect torsion of the substrate 322.

Also, in this illustrated example the first piezoresistive element PZR₁ and the second piezoresistive element PZR₂ are disposed on substantially opposite sides of the rotation axis 328 relative to the third piezoresistive element PZR₃ and the fourth piezoresistive element PZR₄. Also, the first piezoresistive element PZR₁ and the second piezoresistive element PZR₂ are disposed a first distance 330 from the rotation axis 328. Likewise, the third piezoresistive element PZR₃ and the fourth piezoresistive element PZR₄ are disposed a second distance 332 from the rotation axis 328, where the first distance 330 and the second distance 332 are substantially equal.

Turning now to FIG. 3C, a perspective diagram illustrates an exemplary scanner 350. The scanner 350 includes a scan plate 352, a flexure structures 354, a scanner frame 356, and a strain sensor 360. In this illustrated embodiment, the scan plate 352, flexure structures 354 and scanner frame 356 are all formed from a microelectromechanical (MEMS) semiconductor substrate 358. And in this illustrated the scanner frame 356 is a unitary structure that completely surrounds the scan plate 352 and the flexure structures 354.

During operation, the flexure structures 354 facilitate motion of the scan plate 352 relative to the scanner frame 356. In this illustrated embodiment the flexure structures 354 comprise torsion arms that facilitate angular movement of the scan plate 352 by twisting.

The strain sensor 306 is configured to respond to strain in the substrate 358 and can be used to determine the relative motion of the scan plate 352 and/or flexure structures 354. In accordance with the embodiments described herein, the strain sensor 360 is implemented to include four piezoresistive elements 362 electrically coupled together in a Wheatstone bridge circuit. And in accordance with the embodiments described herein, the piezoresistive elements 362 are formed proximate opposite surfaces of the substrate 358. Specifically, two of the piezoresistive elements 362 in the Wheatstone bridge are disposed proximate one surface of the substrate 358, while the other two piezoresistive elements 362 (not shown in FIG. 3C) are disposed proximate the opposite surface of the substrate 358.

An electrical connection between and to the piezoresistive elements 362 in the Wheatstone bridge circuit is provided at least in part by traces 364 and bonding wires 366. Other traces may be formed on the opposite side of substrate 358 that are not shown in FIG. 3C. Furthermore, it should be noted however that this is just one example, and that the electrical connections between piezoresistive elements 362 and other elements and devices can be provided with any combination of vertical interconnects between the opposite sides of the substrate 358, conductive traces on one or both sides of the substrate 358, bonding wires, pads and/or other conductive elements.

In a typical embodiment the scanner 350 would be implemented as part of a scanner assembly. Such a scanner assembly could include the scanner 350, a mirror, a die carrier, a magnet, and other associated elements. In such an embodiment a mirror would be coupled to the scan plate 352 while the scanner frame 356 is affixed to the die carrier in a way that allows the scan plate 352 and mirror to rotate. The die carrier can also provide the electrical connection to the scanner 350, including the connection to the strain sensor 360 via the bonding wires 366. In other embodiments the electrical connections to the scanner 350 can be provided via the bonding wires 366 by another structure, such as printed circuit board (PCB) or flex PCB. These electrical connections can also include connections to coil traces on the scan plate 352 such that a drive circuit can drive an appropriate signal onto the coil traces. These coil traces can include coil loops, where the coil loops generate an electromagnetic field that interacts with the magnet to generate motion of the scan plate 352 and the attached mirror.

The various strain sensors described herein (e.g., strain sensors 108, 220, 240, 320 and 360) can each provide improved sensing performance. Again, by disposing the piezoresistive elements proximate opposite surfaces of the scanner substrate and “rotating” piezoresistive elements proximate one surface relative to a standard diamond configuration, the piezoresistive elements can exhibit impedance changes that are similar or the same in magnitude but opposite in direction when the substrate is under torsional strain. This leads to an increase in signal at the sensing nodes. Furthermore, the piezoresistive elements can exhibit impedance changes that are similar or the same in magnitude and in the same direction when the substrate is under lateral strain. This leads to signal cancelation at the sensing nodes and can decrease the sensitivity of the strain sensor to laterally induced strains. Thus, there is less signal activity caused by lateral motions of the scan plate relative to the increased signal activity caused by angular movement of the scan plate.

Stated another way, the strain field generated by lateral motions on opposite surfaces cause the Wheatstone bridge in the strain sensor to at least partially cancel or otherwise remain balanced. This balancing or partial cancellation of the effects of lateral motion in the Wheatstone bridge can improve the signal-to-noise ratio and provide a signal with reduced harmonic distortions.

Specifically, lateral motions of the scan plate can generate higher mode signals with higher frequencies than the signals caused by torsional motion When amplified, these high frequency signals caused by lateral motion can cause harmonic distortions. While these harmonic distortions can be filtered this would require additional computing power and causes an increase in signal latency. By partially canceling the signals due to lateral motions these harmonic distortions are reduced without requiring the computing power for filtering and the resulting signal latency. Thus, the signal sensors described herein can reduce the effects of lateral motions and reduce the need for signal filtering.

The various strain sensors 108, 220, 240, 320 and 360 described above can be implemented in a variety of devices, including a variety of scanning laser devices used for object detection and/or image projection. In such embodiments the strain sensors can be used to provide precise control of scanning mirrors that can be used to scan and/or receive laser light. In such embodiments one or more mirrors would be coupled to or be formed as part of the scan plate (e.g., scan plates 102 or 352 described above).

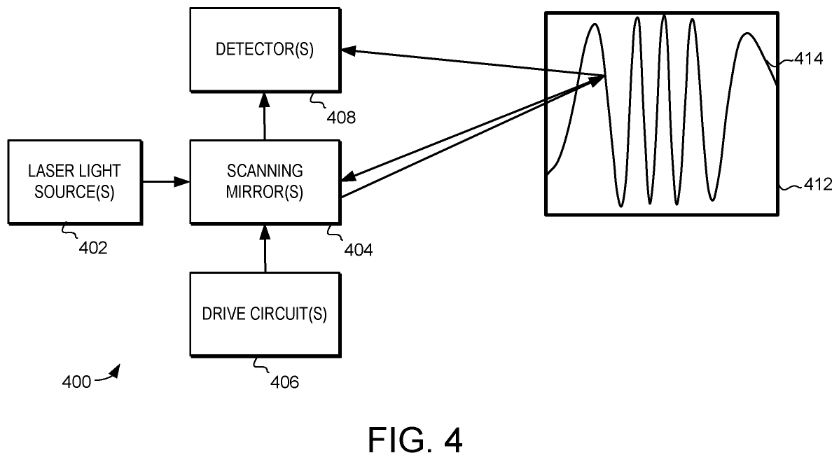

Turning now to FIG. 4, a schematic diagram of an exemplary scanning laser device 400 is illustrated. The scanning laser device 400 includes a laser light source(s) 402, scanning mirror(s) 504, drive circuit(s) 406 and detector(s) 408 In accordance with the embodiments described herein, one or more the scanning mirror(s) 504 can be implemented with scanners utilizing the strain sensors described above (e.g., strain sensors 108, 220, 240, 320 and 360). Such a scanning laser device 400 can be implemented to perform a variety of functions. For example, the scanning laser device 400 can be implemented to facilitate laser depth scanning, LIDAR, 3D motion sensing, gesture recognition, image projection, etc.

As one example, in a scanning laser device 400 implemented to provide image projection, laser light pulses would be encoded with pixel data to generate image pixels. As another example, in a scanning laser device 400 implemented for detection the laser light pulses can include infrared or other suitable laser pulses used to generate the depth mapping pulses.

During operation, the laser light sources 402 generate pulses of laser light that are reflected by the scanning mirrors 404 to a scan field 412. Specifically, the laser light pluses are scanned along a pattern 414 of scan lines inside the scan field 412. These pulses of laser light can impact objects in the scan field 412 at multiple scan locations or measurement points. Reflections of the laser light pulses reflect back from these the scan locations or measurement points on the objects. In some embodiments, one or more of the scanning mirrors 404 may operate as receive mirrors that direct reflections of the laser light pulses received at the scanning laser device 400 to the detectors 408. In other embodiments the detectors 408 may directly receive reflections of the laser light pulses.

In general, the detectors 408 are configured to detect these reflections of the laser light pulses from the scan locations or measurement points on objects within the scan field 412. Signals generated by the detectors 408 may then be used for object detection and/or 3D map generation. For example, time-of-flight (TOF) measurements of the received reflections to generate measurement distances. As one specific example, these measurement distances can be used to generate 3-dimensional point clouds that describe the depth or distance at each point, and thus can be used to generate a depth map of any detected objects.

To facilitate this, the drive circuits 406 control the movement of the scanning mirrors 404. In a typical embodiment the drive circuits 406 can use the strain sensors described above to determine angular mirror positions and precisely control the mirror movement. The angular position of the mirror when a pulse is emitted can be used in post processing to determine the location of measurement points and thus to generate a 3D point cloud.

In such embodiments the strain sensors can be implemented to provide feedback signals that describe the driven deflection angles of the scanning mirrors 404. These feedback signals can be used by the drive circuits 406 to more accurately provide drive signals that control the motion of the scanning mirrors 404. Specifically, in these embodiments, drive circuits 406 can include one or more feedback loops to modify the drive signals in response to the measured angular deflection of the scanning mirrors 404. In addition, in some embodiments, drive circuits 406 include one or more phase lock loop circuits that estimate the instantaneous angular position of the scanning mirrors 404 based on the feedback signals.

As one example, the drive circuits 406 can be implemented to excite resonant motion of the scanners such that a peak amplitude of the feedback signal(s) are kept constant. Such an implementation can provide for a stable angular deflection of the scan plates in the scanners, and thus can provide precise mirror control.

Additionally, the drive circuits 406 can be implemented to synchronously drive the scanning mirrors 404. For example, the scanning mirrors 404 used to direct the laser light pulses to the scan field (e.g., transmit scanning mirrors) can be synchronously driven with the scanning mirrors 404 used to receive reflections of the laser light pulses (e.g., receive scanning mirrors). The precise control of the scanning mirrors 404 is particularly important these devices that use synchronous mirror movement to scan and direct reflections of light pulses from measurement points in the scan field 412 to the detectors 408. Such embodiments will be described in greater detail below.

To facilitate this, the drive circuits 406 may be implemented in hardware, a programmable processor, or in any combination. For example, in some embodiments, drive circuits 460 are implemented in an application specific integrated circuit (ASIC). Further, in some embodiments, some of the faster data path control is performed in an ASIC and overall control is provided by a software programmable microprocessor.

In some embodiments the strain sensors described above can be used to detect the angular position or angular extents of the mirror deflection in multiple axes. For example, in some embodiments, a first strain sensor delivers a voltage signal that is proportional to the deflection of the mirror on one axis (e.g., a fast axis) while a second strain sensor delivers a voltage signal that is proportional to the deflection of the mirror in another axis (e.g., a slow axis).

Turning now to FIG. 5, a scanning light detection and ranging (LiDAR) system 500 in accordance with various embodiments is illustrated. LiDAR system 500 includes emission control circuit 584, pulse generation circuit 590, 3D point cloud storage device 546, OR gate 580, and control circuit 554. LiDAR system 500 also includes transmit module 510, receive module 530, TOF and short-range detection circuits 540, and TOF and short-range detection circuits 550.

The LiDAR system 500 is another example of the type of scanning laser device that can be implemented with scanners and strain sensors embodiments described herein (e.g., strain sensors 108, 220, 240, 320 and 360. In this example transmit module 510 includes an IR laser light source to produce a pulsed laser beam, collimating and focusing optics, and one or more scanning mirror assemblies implemented together in an optical assembly to scan the pulsed laser beam in two dimensions in the field of view. Each of these scanning mirror assemblies can include one or more scanners and strain sensors as described herein. Transmit module 510 also includes an IR laser light detector that shares an optical path with emitted IR laser light pulses. Example embodiments of transmit modules are described more fully below with reference to later figures.

Receive module 530 includes optical devices and one or more scanning mirror assemblies to scan in two dimensions to direct reflected light from the field of view to an included IR light detector. Again, each of these scanning mirror assemblies can include one or more scanners and strain sensors as described herein. Example embodiments of receive modules are described more fully below with reference to later figures.

In this example, the emission control circuit 584 and pulse generation circuit 590 operate to control the transmit module 510 to selectively emit relatively low energy emission control pulse sets that are used to detect when objects (e.g., persons) are within relatively close first and second safety ranges. Then, higher energy long-range pulse sets are conditionally emitted only when objects are not detected within the first and second safety range, thus improving eye-safety.

The LiDAR system 500 includes two separate IR detectors and TOF and short-range detection circuits for detecting reflections of IR laser pulses. Specifically, the receive module 530 includes a first IR detector implemented to detect reflections from both short-range pulse sets (e.g., emission control pulse sets) and long-range pulse sets (e.g., ranging pules), while the transmit module 510 includes a second IR detector that provides for the redundant detection of reflections from relatively low energy short-range emission control pulse sets to provide increased eye safety.

Each of TOF and short-range detection circuits 540 and 550 can include a TOF measurement circuit and comparator to determine when objects are detected within a relative close safety range.

Control circuit 554 controls the movement of scanning mirrors within transmit module 510 and the movement scanning mirrors within receive module 530. As such, control circuit 554 can include one or more drive circuits as described above. In operation, control circuit 554 receives mirror position feedback information from transmit module 510, and also receives mirror position feedback information (not shown) from receive module 530. In each case the mirror position feedback information can be generated using one or more strain sensors as described above. This mirror position feedback information can used to phase lock the operation of the mirrors, and thus to provide for synchronization movement of mirrors in transmit module 510 and receive module 530.

Specifically, control circuit 554 drives microelectromechanical (MEMS) assemblies with scanning mirrors within transmit module 510 with drive signal(s) 545 and also drives MEMS assemblies with scanning mirrors within receive module 530 with drive signal(s) 547 that cause the mirrors to move through angular extents of mirror deflection that define the scan trajectory 542 and the size and location of scan field 528. The synchronization of transmit and receive scanning allows the receive aperture to only accept photons from the portion of the field of view where the transmitted energy was transmitted. This results in significant ambient light noise immunity. Again, the mirror position feedback information can be generated using one or more strain sensors as described above and used to facilitate the synchronization of transmit and receive scanning.

The emission control circuit 584 and pulse generation circuit 590 control the timing and energies of the pulses emitted by transmit module 510. For example, the pulse generation circuit 590 can include a laser light source controller configured to vary the energy level of the laser light pulses emitted by the transmit module 510. As such, the emission control circuit 584 can be implemented to control the timing and energy of emitted emission control pulse sets and ranging pulse sets.

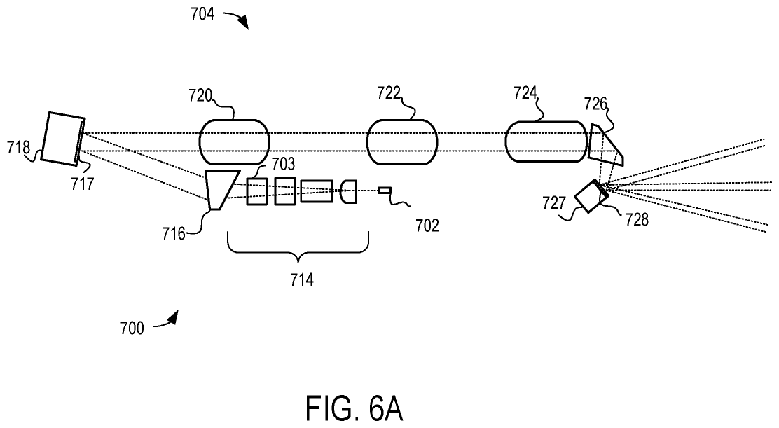

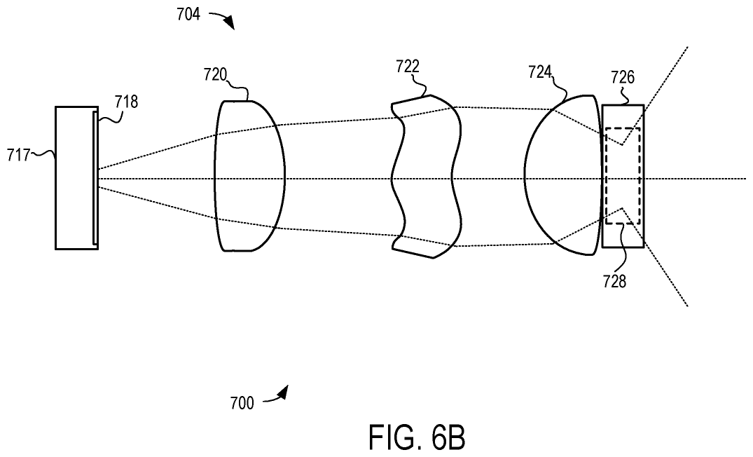

Turning now to FIGS. 6A and 6B, side and top views of an exemplary scanning laser device 700 are illustrated. Again, the scanning laser device 700 is an example of the type of device that can be implemented with the strain sensors described above.

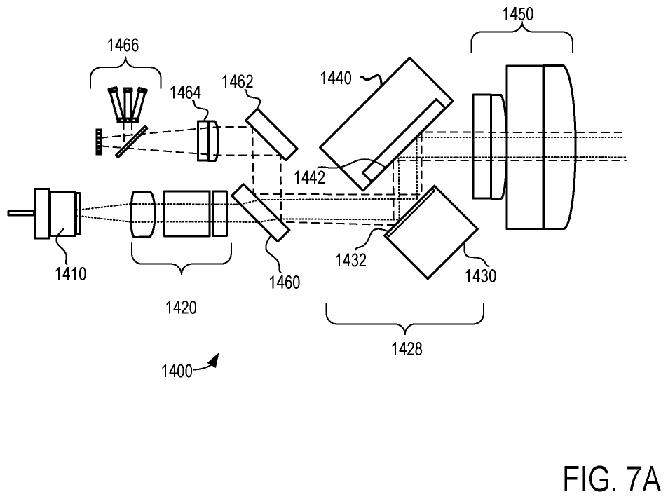

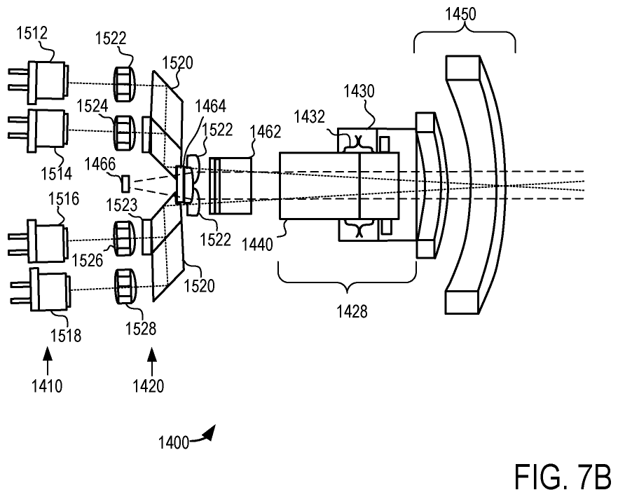

In one embodiment, the scanning laser device 700 is a light LiDAR system used for object detection and/or 3D map generation. The scanning laser device 700 includes a laser light source 702 and an optical assembly 704. The optical assembly 704 is one example of the type of optical assembly that can be used in a LiDAR or other scanning laser device (e.g., scanning laser device 400) in accordance with the embodiments described herein. As such, the optical assembly 704 includes a variety of optical elements used to facilitate scanning. It should be noted that FIGS. 7A and 7B are simplified examples, and thus do not show all of the elements or features of a fully implemented scanning laser device or optical assembly.

The optical assembly 704 illustrated in FIG. 6A includes beam shaping optics 714, a first prism 716, a first scanning mirror assembly 717, first scanning mirror(s) 718, expansion optics that include three expansion lenses 720, 722, 724, a second prism 726, a second scanning mirror assembly 727, and second scanning mirror(s) 728.

During operation of scanning laser device 700 the laser light source 702 generates laser light pulses that are scanned by the optical assembly 704 into a scan trajectory. For example, the laser light source 702 can comprise one or more infrared (IR) lasers driven by field effect transistors (FETs) to generate IR laser light pulses.

In general, pulses from multiple IR laser light sources are first combined and shaped by the beam shaping optics 714 and associated optical elements. The beam shaping optics 714 can thus include any optics for changing the beam shape of the laser light pulses. For example, the beam shaping optics 714 can include collimating lenses, polarizing combiners, anamorphic prism pairs to improve divergence and other such elements. In one embodiment a pick-off beam splitter or prism 703 is implemented within the beam shaping optics 714 to direct reflections to the detector (not shown in FIGS. 7A and 7B) configured for relatively short-range pulse detection.

The output of the beam shaping optics 714 is passed to first prism 716 that kicks the beams up to the first scanning mirror 718. In this illustrated embodiment, the first scanning mirror 718 provides for horizontal scanning motion, while the second scanning mirror 728 provides for vertical scanning motion. Furthermore, in this example the first scanning mirror 718 is driven to provide the scanning motion at a relatively fast scan rate, while the second scanning mirror 728 is driven to provide motion at a relatively slow scan rate. However, these are just examples, and other implementations are possible. Together, this scanning mirror motion results in the laser light pulses being scanned into scan trajectory. It should be noted labels “vertical” and “horizontal” used herein are somewhat arbitrary, since a 90 degree rotation of the scanning laser device will effectively switch the horizontal and vertical axes.

The output of the first scanning mirror 718 is passed to the three expansion lenses 720, 722, 724 which together provide the expansion optics. In general, the expansion optics are implemented to provide an expansion of the scan field in the horizontal direction.

Specifically, in this illustrated example the three expansion lenses 720, 722, 724 are implemented to image the output of the first scanning mirror 718 onto the second scanning mirror 728 while providing a non-uniform expansion in the horizontal direction. As one specific example, the first scanning mirror 718 can be implemented to provide a scanning angle in the horizontal direction of 40 degrees, and the expansion lenses 720, 722, 724 can be implemented to provide a non-uniform expansion to expand the scanning angle to 110 degrees.

In one specific example, the three expansion lenses 720, 722, 724 implement a 4F optical system that images the output of the first scanning mirror 718 onto the second scanning mirror 728. Specifically, the three expansion lenses 720, 722, 724 provide a 4F optical system with magnification that varies with the angle coming from the first scanning mirror 718. The result of these three expansion lenses 720, 722, 724 is a non-uniform variation in optical expansion of the exit scan angle provided by the first scanning mirror 718. The second prism 726 receives the output of the third expansion lens 724 and directs the beams to the second scanning mirror 728.

Turning now to FIGS. 7A and 7B, FIG. 7A shows a side view and FIG. 7B shows a top view of a transmit module 1400. Transmit module 1400 is an example of transmit module that can be used in a LiDAR system (e.g., transmit module 510 of FIG. 5). Transmit module 1400 is thus another example of the type of device that can be implemented with the strain sensors described above. Transmit module 1400 includes laser light source 1410, beam shaping optical devices 1420, received energy pickoff device 1460, mirror 1462, beam shaping device 1464, IR detector 1466, scanner 1428, and exit optical devices 1450.

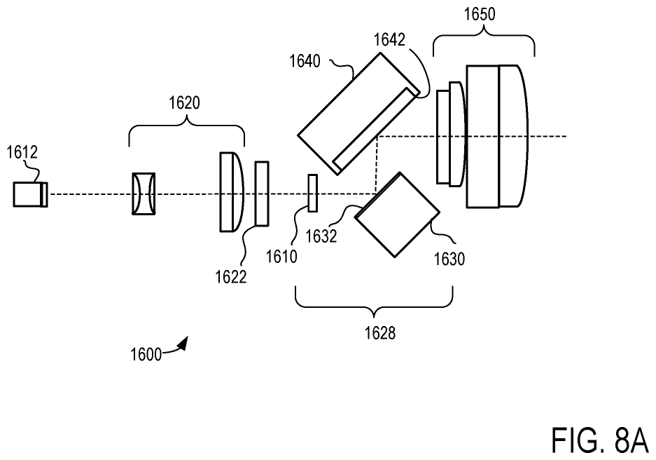

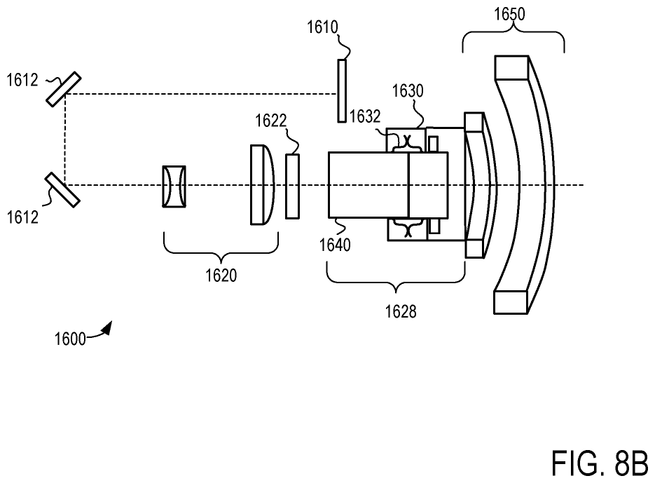

In some embodiments, laser light source 1410 sources generate nonvisible light such as infrared (IR) light. In these embodiments, IR detector 1466 detects the same wavelength of nonvisible light, as does an IR detector in receive module 1600 (FIG. 8, discussed below). For example, in some embodiments, laser light source 1410 may include a laser diode that produces infrared light with a wavelength of substantially 905 nanometers (nm), and IR detector 1466 detects reflected light pulses with a wavelength of substantially 905 nm. Also, for example, in some embodiments, laser light source 1410 may include a laser diode that produces infrared light with a wavelength of substantially 940 nanometers (nm), and IR detector 1466 detects reflected light pulses with a wavelength of substantially 940 nm. The wavelength of light is not a limitation of the present invention. Any wavelength, visible or nonvisible, may be used without departing from the scope of the present invention.

Laser light source 1410 may include any number or type of emitter suitable to produce a pulsed laser beam. For example, in some embodiments, laser light source 1410 includes multiple laser diodes shown in FIG. 7B at 1512, 1514, 1516, and 1518. The pulsed laser light produced by laser light source 1410 is combined, collimated, and focused by beam shaping optical devices 1420 to produce a pulsed laser beam. For example, optical devices 1522, 1524, 1526, 1528 may collimate the laser beams on the fast axis, polarization rotators 1523 and beam combiners 1520 may combine laser beams, and optical devices 1522 may form the pulsed laser beam into a fan on the slow axis. Beam sizes and divergence values are not necessarily uniform across the various embodiments of the present invention; some embodiments have higher values, and some embodiments have lower values.

Scanner 1428 receives the pulsed laser beam from optical devices 1420 and scans the pulsed beam in two dimensions. In embodiments represented by FIGS. 10A and 10B, scanner 1428 includes two separate scanning mirror assemblies 1430, 1440, each including a scanning mirror 1432, 1442, where each scanning mirror scans the beam in one dimension. For example, scanning mirror 1432 scans the pulsed beam in the fast scan direction, and scanning mirror 1442 scans the pulsed beam in the slow scan direction.

Although scanner 1428 is shown including two scanning mirror assemblies, where each assembly scans in a separate dimension, this is not a limitation of the present invention. For example, in some embodiments, scanner 1428 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 1450 operate on the scanning pulsed laser beam as it leaves the transmit module. In some embodiments, exit optical devices 1450 perform field expansion. For example, scanner 1428 may scan through maximum angular extents of 20 degrees on the fast scan axis, and may scan through maximum angular extents of 40 degrees on the slow scan axis, and exit optical devices 1450 may expand the field of view to 30 degrees on the fast scan axis and 120 degrees on the slow scan axis. The relationship between scan angles of scanning mirrors and the amount of field expansion provided by exit optical devices 1450 is not a limitation of the present invention.

Received energy pickoff device 1460 deflects received light (shown as a dotted line) that shares at least part of the transmit optical path with the emitted light pulses (shown as a solid line). The deflected received light is then reflected by mirror 1462, focused by optical device 1064, and detected by IR detector 1466. In some embodiments, pickoff device 1460 includes a “window” that transmits the pulsed beam produced by the IR laser light source, and a reflective outer portion to deflect received energy outside the window. In other embodiments, pickoff device 1460 is a partial reflector that transmits a portion of incident light and reflects the rest. For example, a reflector that transmits 90% of incident light and reflects 10% of incident light will provide the IR detector 1466 with 10% of the light reflected off an object in the field of view. In still further embodiments, pickoff device 1460 may incorporate a polarizing beam splitter that transmits the pulsed laser beam (at a first polarization), and picks off received light of a different polarization. This is effective, in part, due to the reflections being randomly polarized due to Lambertian reflection. In still further embodiments, the outgoing laser beam and received energy may be directed to different portions of the scanning mirrors, and pickoff device 1460 may be an offset mirror positioned to reflect one but not the other.

To facilitate reliable detection of low energy emission control pulse sets the IR detector 1466 can be implemented with multiple sensors configured to receive reflections through at least some of the same optical assembly used to transmit laser light pulses into the scan field. Specifically, the IR detector 1466 can be configured to receive laser light pulses through the same scanning mirrors 1432, 1142, exit optical devices 1450, and other optical elements used to transmit the laser light pulses into the scan field. Because the same optical assembly is used by the multiple sensors to receive the laser light reflections any damage or blockage that prevents the multiple sensors from receiving the reflections from emission control pulse sets would also have likely blocked the scanning of the laser light pulses into the scan field. Thus, the IR detector 1466 can more reliably detect emission control pulse sets that have impacted an object in the safety range of the scan field and reflected back toward the detector, and can thus be used to reliably determine when long-range pulse sets can be emitted safely. Furthermore, the multiple sensors in the IR detector 1466 are configured to at least partially cancel the effects of back reflections from within the optical assembly. The cancellation of the effects of back reflections from within the optical assembly can improve the sensitivity of the detector, particularly for the detection of low energy emission control reflections from within the scan field.

Turning now to FIGS. 8A and 8B, FIG. 8A shows a side view and FIG. 8B shows a top view of a receive module 1600. Receive module 1600 is an example of receive module that can be used in a LiDAR system (e.g., receive module 530 of FIG. 5). Receive module 1600 is thus another example of the type of device that can be implemented strain sensors described above. Receive module 1600 includes IR detector 1610, fold mirrors 1612, imaging optical devices 1620, bandpass filter 1622, scanner 1628, and exit optical devices 1650.

Scanning mirror assemblies 1630 and 1640 are similar or identical to scanning mirror assemblies 1430 and 1440, and exit optical devices 1650 are similar or identical to exit optical devices 1450. Bandpass filter 1422 passes the wavelength of light that is produced by laser light source 1410, and blocks ambient light of other wavelengths. For example, in some embodiments, the laser light source produces light at 905 nm, and bandpass filter 1622 passes light at 905 nm.

Imaging optical devices 1620 image a portion of the field of view onto IR detector 1610 after reflection by fold mirrors 1612. Because scanner 1628 is scanned synchronously with scanner 1428, detector 1610 always collects light from the measurement points illuminated by the scanned pulsed beam.

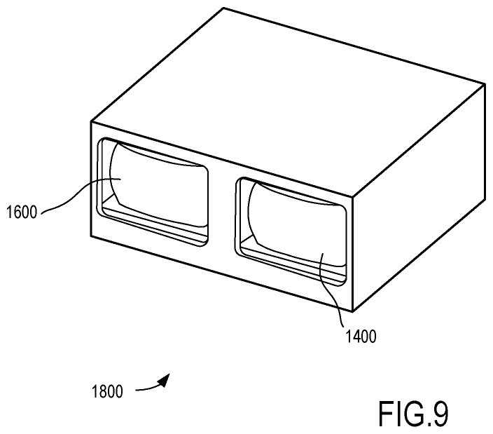

FIG. 9 shows a perspective view of an integrated photonics module in accordance with various embodiments of the present invention. Integrated photonics module 1800 includes both transmit module 1400 (FIGS. 7A and 7B) and receive module 1600 (FIGS. 8A and 8B). Integrated photonics module 1800 is shown having a rectangular housing with transmit module 1400 and receive module 1600 placed side by side. In some embodiments, transmit module 1400 and receive module 1600 are placed one on top of the other.

In the preceding detailed description, reference was made to the accompanying drawings that show, by way of illustration, specific embodiments in which the invention may be practiced. These embodiments were described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The preceding detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A microelectromechanical systems (MEMS) scanner, comprising:
a scan plate, the scan plate including a scan plate surface;
a first flexure structure extending from the scan plate;
a scanner frame at least partially surrounding the scan plate, the first flexure structure, wherein the scan plate, the first flexure structure, and the scanner frame are all formed from a semiconductor substrate, the semiconductor substrate having a first surface and a second surface opposite the first surface; and
a strain sensor disposed on the semiconductor substrate, the strain sensor including a first, a second, a third and a fourth piezoresistive element electrically coupled together to form a Wheatstone bridge circuit, where the first and the second piezoresistive elements are disposed proximate the first surface of the semiconductor substrate, and where the third and fourth piezoresistive elements are disposed proximate the second surface of the semiconductor substrate.

2. The MEMS scanner of claim 1, wherein the first piezoresistive element has a first current axis, the second piezoresistive element has a second current axis, the third piezoresistive element has a third current axis, and the fourth piezoresistive element has a fourth current axis, and wherein the first piezoresistive element and the third piezoresistive element are disposed such that the first current axis is parallel to the third current axis in the semiconductor substrate and wherein the second piezoresistive element and the fourth piezoresistive element are disposed such that the second current axis is parallel to the fourth current axis in the semiconductor substrate.

3. The MEMS scanner of claim 2, wherein the first piezoresistive element and the second piezoresistive element are disposed such that the first current axis is perpendicular to the second current axis in the semiconductor substrate and the third piezoresistive element and the fourth piezoresistive element are disposed such that third current axis is perpendicular to the fourth current axis in the semiconductor substrate.

4. The MEMS scanner of claim 3, wherein the first flexure structure provides for angular movement of the scan plate about a rotation axis, and wherein the first piezoresistive element and the second piezoresistive element are disposed on substantially opposing sides of the rotation axis and wherein the third piezoresistive element and the fourth piezoresistive element are disposed on substantially a same side of the rotation axis.

5. The MEMS scanner of claim 3, wherein the first flexure structure provides for angular movement of the scan plate about a rotation axis, and wherein the first piezoresistive element and the second piezoresistive element are disposed such that the first current axis and the second current axis intersect at the rotation axis and wherein the third piezoresistive element and the fourth piezoresistive element are disposed such that third current axis and the fourth current axis intersect at a point offset from the rotation axis.

6. The MEMS scanner of claim 2, wherein the first piezoresistive element and the third piezoresistive element are disposed such that the first current axis is coplaner with the third current axis in the semiconductor substrate.

7. The MEMS scanner of claim 1, wherein the first flexure structure provides for angular movement of the scan plate about a rotation axis and where the first surface and the second surface are on substantially opposing sides of the rotation axis, and wherein the first and the second piezoresistive elements are disposed a first distance from the rotation axis, and wherein the third and fourth piezoresistive elements are disposed a second distance from the rotation axis, and wherein the first distance and the second distance are substantially equal.

8. The MEMS scanner of claim 1, wherein the Wheatstone bridge circuit includes a first sensing node between the first and the second piezoresistive elements and includes a second sensing node between the third and fourth piezoresistive elements, and wherein the Wheatstone bridge circuit provides a signal indicative of the angular movement of the scan plate about a rotation axis at the first sensing node and the second sensing node.

9. The MEMS scanner of claim 1, wherein the semiconductor substrate comprises a portion of a silicon wafer, and wherein the first piezoresistive element, the second piezoresistive element, the third piezoresistive element and the fourth piezoresistive element each comprise a doped regions in the portion of the silicon wafer, and wherein the first surface comprises a first wafer slice surface of the silicon wafer and the second surface comprises a second wafer slice surface of the silicon wafer.

10. The MEMS scanner of claim 1, further comprises a second flexure structure extending from the scan plate, and wherein the first flexure structure comprises a first torsion arm, and wherein the second flexure structure comprises a second torsion arm.

11. A microelectromechanical systems (MEMS) scanner, comprising:
a scan plate, the scan plate including a scan plate surface;
a first flexure structure extending from the scan plate;
a second flexure structure extending from the scan plate, where the first flexure structure and the second flexure structure provides for angular movement of the scan plate about a rotation axis;
a scanner frame at least partially surrounding the scan plate, the first flexure structure, and the second flexure structure, wherein the scan plate, the first flexure structure, the second flexure structure, and the scanner frame are all formed from a MEMS semiconductor substrate, the semiconductor substrate having a first surface and a second surface opposite the first surface such that the first surface and the second surface are on substantially opposing sides of the rotation axis; and
a strain sensor disposed in the MEMS semiconductor substrate, the strain sensor including:
a first piezoresistive element disposed in the scanner frame proximate the first surface, and where the first piezoresistive element has a first current axis;
a second piezoresistive element disposed in the scanner frame proximate the first surface, where the second piezoresistive element has a second current axis, and where the second current axis is perpendicular to the first current axis;
a third piezoresistive element disposed in the scanner frame proximate the second surface, where the third piezoresistive element has a third current axis, and where the third current axis is coplanar with the first current axis;
a fourth piezoresistive element disposed in the scanner frame proximate the second surface, where the fourth piezoresistive element has a fourth current axis, where the fourth current axis is perpendicular to the third current axis;
and wherein the first piezoresistive element, the second piezoresistive element, the third piezoresistive element, and the fourth piezoresistive element are electrically coupled together to form a Wheatstone bridge circuit that includes a first sensing node between the first and the second piezoresistive elements and includes a second sensing node between the third and fourth piezoresistive elements, and wherein the Wheatstone bridge circuit is configured to provide a signal indicative of the angular movement of the scan plate about the rotation axis at the first sensing node and the second sensing node.

12. A scanning laser device, comprising:
a laser light source to generate pulses of laser light;
a microelectromechanical systems (MEMS) semiconductor scanner configured to scan the pulses of laser light, the MEMS semiconductor scanner formed from a MEMS semiconductor substrate, the MEMS semiconductor substrate having a first surface and a second surface; and
a strain sensor disposed on the MEMS semiconductor substrate, the strain sensor including a first, a second, a third and a fourth piezoresistive element electrically coupled together to form a Wheatstone bridge circuit, where the first and the second piezoresistive elements are disposed proximate the first surface of the MEMS semiconductor substrate, and where the third and fourth piezoresistive elements are disposed proximate the second surface of the MEMS semiconductor substrate.

13. The scanning laser device of claim 12, wherein the first piezoresistive element has a first current axis, the second piezoresistive element has a second current axis, the third piezoresistive element has a third current axis, and the fourth piezoresistive element has a fourth current axis, and wherein the first piezoresistive element and the third piezoresistive element are disposed such that the first current axis is parallel to the third current axis in the MEMS semiconductor substrate and wherein the second piezoresistive element and the fourth piezoresistive element are disposed such that the second current axis is parallel to the fourth current axis in the MEMS semiconductor substrate.

14. The scanning laser device of claim 13, wherein the first piezoresistive element and the second piezoresistive element are disposed such that the first current axis is perpendicular to the second current axis in the MEMS semiconductor substrate and the third piezoresistive element and the fourth piezoresistive element are disposed such that third current axis is perpendicular to the fourth current axis in the MEMS semiconductor substrate.

15. The scanning laser device of claim 14, wherein the MEMS semiconductor scanner provides for angular movement of a scan plate about a rotation axis, and wherein the first piezoresistive element and the second piezoresistive element are disposed on substantially opposing sides of the rotation axis and wherein the third piezoresistive element and the fourth piezoresistive element are disposed on substantially a same side of the rotation axis.

16. The scanning laser device of claim 14, wherein the MEMS semiconductor scanner provides for angular movement of a scan plate about a rotation axis, and wherein the first piezoresistive element and the second piezoresistive element are disposed such that the first current axis and the second current axis intersect at the rotation axis and wherein the third piezoresistive element and the fourth piezoresistive element are disposed such that third current axis and the fourth current axis intersect at a point offset from the rotation axis.

17. The scanning laser device of claim 13, wherein the first piezoresistive element and the third piezoresistive element are disposed such that the first current axis is coplaner with the third current axis in the MEMS semiconductor substrate.

18. The scanning laser device of claim 12, wherein the MEMS semiconductor scanner provides for angular movement of a scan plate about a rotation axis and where the first surface and the second surface are on substantially opposing sides of the rotation axis, and wherein the first and the second piezoresistive elements are disposed a first distance from the rotation axis, and wherein the third and fourth piezoresistive elements are disposed a second distance from the rotation axis, and wherein the first distance and the second distance are substantially equal.

19. The scanning laser device of claim 12, wherein the Wheatstone bridge circuit includes a first sensing node between the first and the second piezoresistive elements and includes a second sensing node between the third and fourth piezoresistive elements, and wherein the Wheatstone bridge circuit provides a signal indicative of the angular movement of a scan plate about a rotation axis at the first sensing node and the second sensing node.

20. The scanning laser device of claim 12, wherein the MEMS semiconductor substrate comprises a portion of a silicon wafer, and wherein the first piezoresistive element, the second piezoresistive element, the third piezoresistive element and the fourth piezoresistive element each comprise a doped regions in the portion of the silicon wafer, and wherein the first surface comprises a first wafer slice surface of the silicon wafer and the second surface comprises a second wafer slice surface of the silicon wafer.
